(19) United States
(12) Patent Application Publication
(10) Pub. No.: US 2007/0267156 A1
(43) Pub. Date: Nov. 22, 2007

(54) Method for Degassing and Supplying a Fibrous Suspension to a Headbox or a Filter Device and Degassing Device

(75) Inventors: Axel Gommel, Ravensburg (DE); Erwin Binder, Heidenheim (DE)

Correspondence Address: GREENBLUM & BERNSTEIN, P.L.C., 1950 ROLAND CLARKE PLACE, RESTON, VA, 20191, US

(73) Assignee: VOITH PATENT GMBH, Heidenheim (DE)

(21) Appl. No.: 11/574,634

(22) PCT Filed: Sep. 20, 2005
(86) PCT No.: PCT/EP05/10094

§ 371 Date: Mar. 2, 2007

(30) Foreign Application Priority Data
Oct. 21, 2004 (DE) 10 2004 051 327.9

(51) Int. Cl. B01D 33/11

(52) U.S. Cl. 162/58; 162/380

(57) ABSTRACT

The invention serves to feed a fibrous suspension (S) to a headbox (1) of a paper or cardboard machine (2) or to a filter device. The fibrous suspension (S) can be generated, e.g., by mixing a high-consistency suspension (4) with a diluting liquid (5). The method uses at least one degassing device (6), the effect of which corresponds to that of a centrifuge. The method can be carried out in a space-saving manner and makes it possible, e.g., to omit large degassing containers.

The invention relates to a method for feeding a fibrous suspension according to the preamble of claims 1, 3 or 14 and to a degassing device according to the preamble of claim 26.

Methods of this type are used, e.g., for supplying paper or cardboard machines with fibrous suspension. The headbox delivers a fibrous layer onto a passing screen that, i.a., also has the function of thickening. The stock feeding systems required thereto are known in principle. The fibrous suspension to be fed receives the major part of the fibers from a high-consistency suspension provided in the stock preparation unit. The high-consistency suspension has, e.g., a typical consistency of between 2.5 and 5%. With the addition of a diluting liquid, e.g., backwater of the paper machine, the consistency is lowered to a value that is favorable for operating the headbox of the paper machine. Although the backwater is optimally suited for this diluting task, there are, however, problems due to the high gas content, whereby the predominant part is air. The largest proportion of these gases escapes very quickly, the residual gases, however, often have to be removed in a complex manner. Otherwise, the quality of the paper produced would be unduly lowered. Known solutions are large degassing containers in which a permanent negative pressure is maintained by evacuation, which negative pressure corresponds to the steam pressure of the suspension to be degassed. This is effective, but expensive.

A degassing pump for paper production is known from U.S. Pat. No. 6,723,205 B1, which pump is provided with a rotor forming a cylindrical interior, in which rotor the fed liquid can be degassed by centrifugal force. The backwater fed from the paper machine at high speed provides the drive power for the rotor via a turbine integrated into the degassing pump. When it has left the degassing pump, the liquid is guided directly to mixing stations in which the fiber raw material (high-consistency stock) is added.

Another application for methods of this type occurs in the preparation unit (“stock preparation”) for the fibrous suspension designated for processing on the paper or cardboard machine. Filter devices, in particular disk filters, are used to increase the consistency of suspensions with relatively low consistency, e.g., between 0.5% and 1.5%. The fibrous suspension to be thickened can thereby have an air content of several percent, e.g., if it has been floated previously to eliminate contaminants with the flotation foam. The operation of disk filters and pumps is adversely affected by higher air content.

The invention is based on the object of creating a method of the type mentioned at the outset, with which a stock flow is guided to the headbox or to a filter device, which stock flow is degassed sufficiently. It is to require relatively little expenditure and to be reliable in operation.

To attain the object, a method with the features of the independent claims is provided.

The stock feeding system according to the invention is characterized in particular in that a degassing device is used for the degassing of the backwater or the fibrous suspension, which degassing device is constructed in a compact manner and still renders possible a good degassing. In particular it is generally not required to use large complex containers that greatly strain the building during operation because of their high weight. Containers of this type are operated with the steam pressure of the suspension to be degassed, are thus under extreme negative pressure with the strength requirements resulting therefrom. Vacuum systems with high energy consumption are not required either for the method according to the invention.

The method is used in a particularly favorable manner with paper machines, the screen speed of which is between 800 and 1600 m/min. The amount of air contained in the backwater is highly dependent on the screen speed.

The method can also be used if the fibrous suspension is guided via a disk filter for thickening—as is known per se. A disk filter of this type permits a considerably higher flow rate if the air content of the liquid flowing in is lowered.

Another essential advantage of the invention is that, apart from the fact that the further transport of the deaerated fiber suspension leaving the degassing container is ensured by the stock pump connected to the degassing device, a lower pressure promoting the degassing can be set in the degassing device, as the pump exerts a suction.

In an advantageous embodiment the rotor of the degassing device is driven by a motor, e.g., an electric motor. The peripheral speed of the rotor is thus easy to set to the value corresponding to the requirements.

The invention is explained on the basis of drawings. They show:

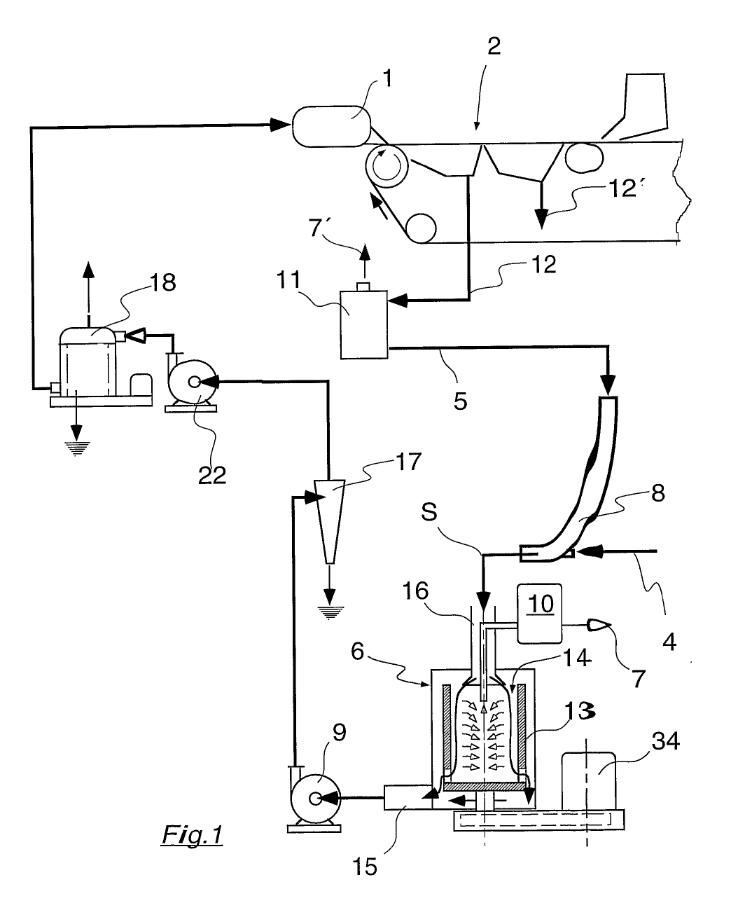

FIG. 1 A simplified diagram of the method;

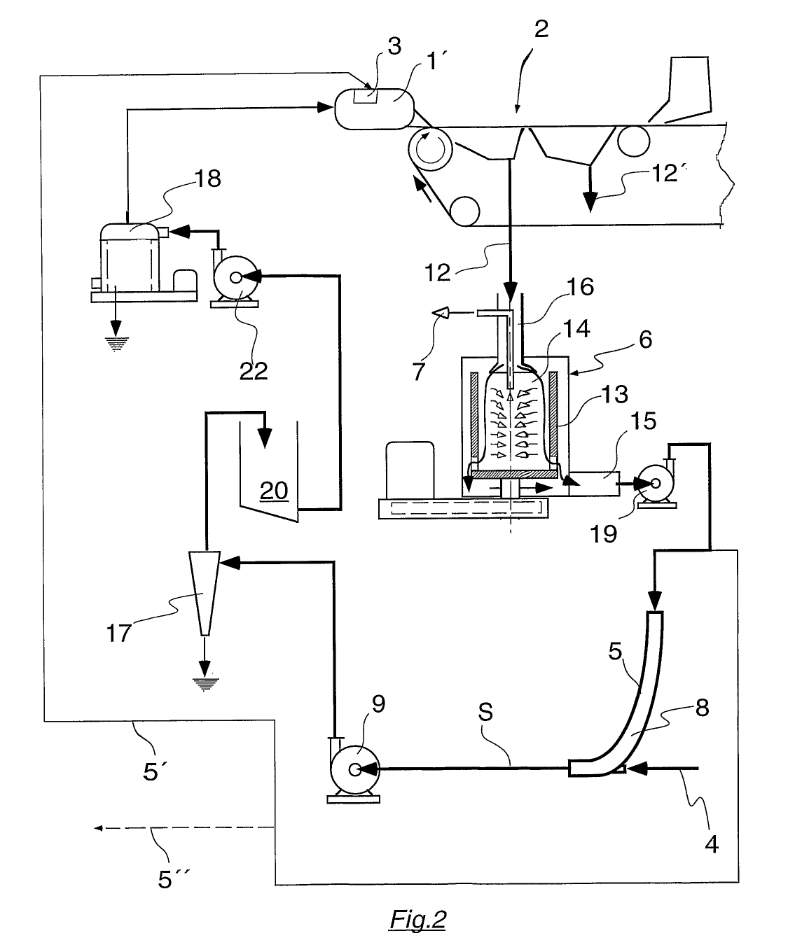

FIG. 2 A variation;

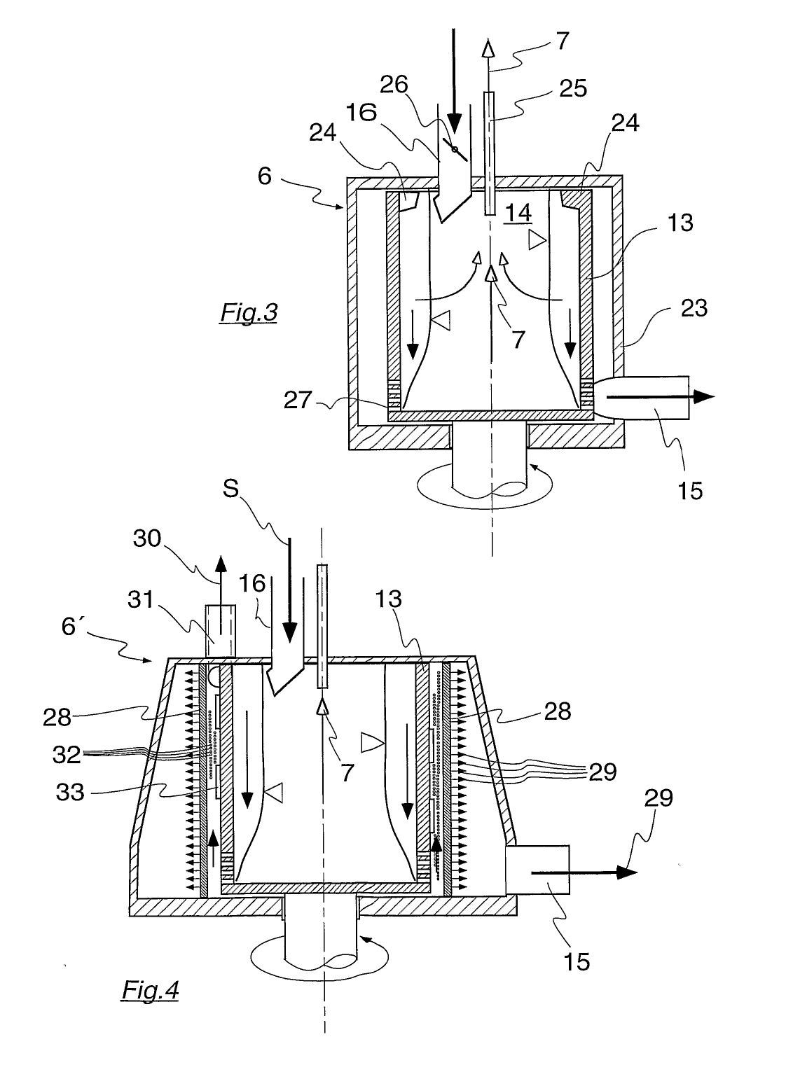

FIG. 3 A degassing device according to the invention;

FIG. 4 A degassing device according to the invention with screening function;

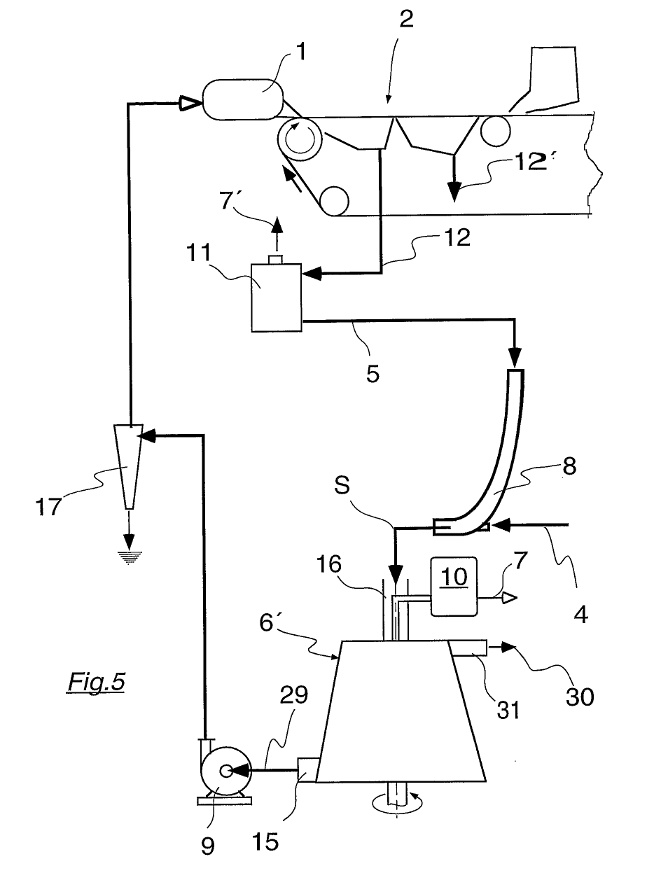

FIG. 5 Another embodiment of the method;

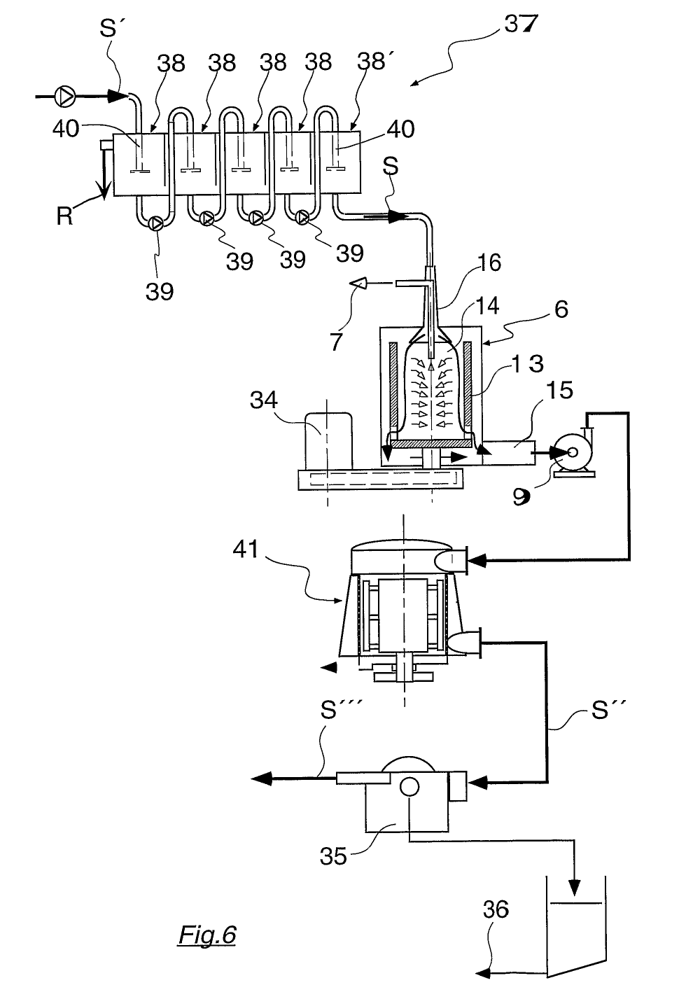

FIG. 6 An application of the method in stock preparation.

The diagram of FIG. 1 shows a first example for carrying out the method according to the invention. A fibrous suspension S is generated in the customary manner by mixing a high-consistency suspension 4 with a diluting liquid 5 and then has essentially the consistency desired at this point for the operation of the headbox 1 of the paper or cardboard machine 2. As is known, headbox consistencies are in the range of between 0.5 and 2%, generally around 1%. In the example shown here, the diluting liquid 5 fed at a mixing site 8 comes from the first backwater 12, i.e., the water accumulated in the forming area of the paper or cardboard machine 2. It is often referred to as backwater I (SW I), as opposed to the second backwater 12′ (SW II) accumulating on the paper machine at a later point, which second backwater contains far fewer fines.

It is known that backwater of this type is mixed, i.a., with a considerable proportion of air and potentially with other gases. The backwater is caught below the paper machine screen and drained off at the side. A large part of the air contained can already escape in the open channels used for this. But it is often expedient to eliminate a further gas proportion 7′ in a special container 11, as known, e.g., from DE 199 38 799. As a supporting measure, the container 11 can be under a moderate negative pressure. After high-consistency suspension 4 and diluting liquid 5 have been mixed, a degassing device 6 is used. This is constructed as a cylindrical or conical container and provided according to the invention with a rotor 13. The rotor 13 is driven by a motor 34 which is not powered from the hydraulic energy of the degassed suspension flow, e.g., an electric motor. The fibrous suspension S reaches the essentially cylindrical interior 14 of the rotor 13 and is put into rapid rotation. This principle corresponds to that of a solid bowl centrifuge. As a result of the centrifugal forces, the gases 7 contained move inward and are suctioned off from the center by a vacuum device 10 (merely indicated roughly). A liquid/gaseous phase boundary thereby forms in the container. The centrifugal forces can be at least 5 times, preferably 10 times the acceleration of gravity. The vacuum device 10 requires no negative pressure that corresponds to or is similar to the steam pressure of the suspension. Values customary for the negative pressure of a vacuum device 10 used here are approximately 0.8 to 0.9 bar.

After leaving the degassing device 6, the suspension is guided via a stock pump 9 to the headbox 1—here in a closed system (i.e., without any open containers or vats). In the customary manner, the remainder of the contaminants still present is thereby eliminated here by a cleaner unit 17 and a screening unit 18. In order to prevent the pressure in the cleaner unit 17 from becoming too high, a pump 22 (“booster pump”) can be installed to increase the pressure between accepts of the cleaner unit 17 and intake to the screening unit 18. Alternatively, an open intermediate vat 20 can also be provided for the stock guidance after the stock pump 9, e.g., in order to reduce pulsations. This is shown in FIG. 2, but can also be realized in a unit according to FIG. 1. The expenditure necessary for these hydrocyclones and screens will naturally depend on the raw materials and the demands on the quality of the paper produced. If, e.g., the high-consistency suspension 4 was generated from recovered paper, sand and small plastic parts may still be present.

The invention can also be embodied such that—as FIG. 2 shows—the backwater 12 of the paper or cardboard machine 2 is degassed in a degassing device 6′, the function of which corresponds to that already described in connection with FIG. 1. The degassed backwater is guided through the outlet 15 directly into a diluting water pump 19. The degassing can be carried out much more easily because of the considerably lower solids proportion of the backwater 12 as compared to the fibrous suspension S. In order to prevent any losses in terms of quality, this requires, however, at most just a low gas content in the high-consistency suspension 4 added at the mixing site 8.

As is known, there are many paper or cardboard machines in which the headbox is supplied not only with the fibrous suspension S already mentioned, but in addition with a diluting liquid which is added in a metered manner at various points seen over the width of the headbox 1. It is thus possible to influence, in particular optimize, e.g., the cross profile of the fibrous layer formed with the headbox. FIG. 2 shows an option of this type, in which the backwater is used not only as diluting liquid 5 for the high-consistency suspension 4. A part of the backwater deaerated in the degassing device 6′ is guided as a diluting liquid 5′ into a metering device 3 of the headbox 1′ by means of the diluting water pump 19, in which metering device it is subdivided and added in a metered manner to the fibrous suspension S at various points. In a paper mill there are often further points at which further diluting liquid 5′ deaerated by the method can be used, which is indicated here by a dashed arrow.

Without showing constructive details, FIG. 3 shows in section a degassing device 6 suitable for the method. A rotor 13 is arranged in a stationary housing 23, the interior 14 of which rotor is supplied with a liquid to be degassed through the inlet 16. The inlet 16 can be arranged centrally or, as here, eccentrically. The liquid added through it is first greatly accelerated in the circumferential direction, for which, e.g., acceleration ribs 24 can be used. As a result of the centrifugal forces the liquid bears against the interior wall of the rotor 13, whereby the gas contained therein, in particular the air, moves toward the center of the rotor 13. As a rule, a discontinuity surface forms between the liquid and the gas 7. The gas 7 can be discharged or suctioned off through a central degassing tube 25. With a continuous operation of this degassing device, the operating conditions can be controlled, e.g., by means of an input throttle 26, such that an uninterrupted liquid flow forms from the inlet 16 to the outflow 15. In the area of the outflow 15 the wall of the rotor 13 is thereby embodied to be permeable to liquids, e.g., by placing openings 27 in this area. Advantageously, the outflow 15 is mounted tangentially such that the rotational flow of the degassed liquid causes a pressure build-up in the outflow 15. The openings 27 in the wall of the rotor 13 are so big that they do not lead to a screening of the degassed liquid.

The embodiment of a degassing device 6′ shown in FIG. 4 combines the function of degassing with the function of screening. As already mentioned, the last screening stage is often placed upstream of the headbox when supplying a paper machine, in order to prevent contaminants from getting into the headbox which interfere with the operation of the headbox or the paper machine. This screening function can be carried out in combination with the degassing function in the same device. To this end a screen basket 28 is arranged such that the degassed liquid flowing radially outward from the rotor 13′ is fed to the screen basket 28. In a manner known per se, a separation into accepts 29 and rejects 30 occurs at the screen openings 32 of the screen basket 28. The rejects can be drained off out of the device through a reject outflow 31. By way of example and not to scale, only some of the screen openings 32 in the screen basket 28 are drawn. The combination has the advantage that the rotor 13′ can also serve to keep the screen openings 32 clear. To this end clearing elements 33 are mounted on its outside, which are capable of generating suitable suction and pressure impulses in the fiber suspension.

FIG. 5 shows a diagram of the method using a degassing device 6′ embodied according to FIG. 4. The screens shown in FIG. 1 for the fibrous suspension S can then be omitted. Possibly a cleaner unit 17 is still necessary between the degassing device 6′ and the headbox 1; but this depends on the contaminants present in the fibrous suspension S.

FIG. 6 shows a favorable application of the invention in the stock preparation of a paper mill. A low-consistency fibrous suspension S″ is thickened in a disk filter 35 (only indicated), thus brought to a higher consistency. The stock S′″ thickened by the filter effect can be further treated as a raw material for paper production, whereas the filtrate 36 serves, e.g., for diluting. The reason for a measure of this type is that the steps of the method in stock preparation proceed optimally partly with low and partly with high consistency.

In the unit shown in FIG. 6 a flotation unit 37 is operated which cleans a fibrous suspension S′ mixed with contaminants, e.g., printing ink particles, at low consistency, e.g., between 0.5 and 2%. Of the flotation unit 37, five flotation cells 38, flowed through one after the other, are shown diagrammatically. The accepts of an upstream flotation cell are respectively conveyed into the next flotation cell via a ventilation injector 40 by means of several pumps 39. The rejects R formed, i.e., the flotation foam, contain the eliminated contaminants. The accepts of the last flotation cell 38′ with an air content of, e.g., between 3% and 6% are extracted here by a stock pump 9 downstream of the degassing device 6. This lowers the pressure of the degassing device 6, which further benefits the degassing effect.

The degassing device 6 inserted between the flotation unit 37 and the disk filter 35 removes a large part of the air absorbed, e.g., in the flotation unit 37. The disk filter 35 already allows 10% more throughput, e.g., with a reduction of the air content by one percentage point. If there is, e.g., a reduction from 6% to 1%, the possible throughput is approximately 50% higher. Also other problems connected to a relatively high air content, e.g., at the stock pump 9, are eliminated effectively and economically. The degassing device 6 described is particularly economical especially for objects of this type, in which the last fractional percentage amount of the air content in the degassed liquid is not relevant.

A fine screening 41 is often carried out after the flotation and before the thickening, which fine screening is particularly effective with low consistency (e.g., 0.5 to 2%).

1. Method for feeding a fibrous suspension to at least one headbox (1, 1′) of a paper or cardboard machine (2) with at least one diluting device in which the fibrous suspension (S) is generated by mixing a high-consistency suspension (4) with a diluting liquid (5), in particular water, and at least one device for removing gas from liquid, characterized in that the fibrous suspension (S) is guided into at least one degassing device (6) after the mixing with the diluting liquid (5), in which degassing device it reaches the interior (14) of a rotating rotor (13, 13′) and is put into rotation, so that the gases (7) contained are eliminated because of the centrifugal forces, and that the degassed diluting liquid (5) is guided out of the degassing device (6) into a separate stock pump (9).

2. Method according to claim 1, characterized in that after the degassing device (6) the fibrous suspension (S) is guided to the headbox (1, 1′) in a closed system by means of a stock pump (9), and that the degassing device (6) is arranged directly before the stock pump (9), seen in the flow direction of the fibrous suspension.

3. Method for feeding a fibrous suspension (S) to at least one headbox (1, 1′) of a paper or cardboard machine (2) with at least one diluting device in which the fibrous suspension (S) is generated by mixing a high-consistency suspension (4) with a diluting liquid (5), in particular water, and at least one device for removing gas from liquid, whereby the diluting liquid (5) is guided into at least one degassing device (6) before the mixing with the high-consistency suspension (4), in which degassing device it reaches the interior (14) of a rotating rotor (13, 13′) and is put into rotation, so that the gases (7) contained are eliminated because of centrifugal forces, characterized in that the degassed diluting liquid (5) is guided out of the degassing device (6) into a separate diluting water pump (19).

4. Method according to claim 3, characterized in that the headbox (1′) is provided with a metering device (3), by which the headbox (1′) is supplied with diluting liquid (5′) to control the cross profile of the web produced, for the provision of which the degassing device (6′) is used for the diluting liquid.

5. Method according to claim 3, characterized in that further diluting liquid (5″) is degassed in the degassing device (6′) to supply further diluting sites.

6. Method according to claim 1, characterized in that a wet screening is carried out in the degassing device (6′) to remove contaminants from the fibrous suspension (S) by guiding the degassed liquid out of the interior (14′) to a screen basket (28) built into the degassing device (6′).

7. Method according to claim 6, characterized in that the rotor (13′) is also used to keep the screen basket (28) clear.

8. Method according to claim 6, characterized in that the screen basket (28) is inserted radially outside the rotor (13′).

9. Method according to claim 1, characterized in that the diluting liquid (5) is backwater (12) of the paper or cardboard machine (2).

10. Method according to claim 9, characterized in that the backwater (12) is pre-degassed in open channels before entering the degassing device (6′) or the mixing site (8).

11. Method according to claim 1, characterized in that the fibrous suspension (S) is guided to the headbox (1, 1′) in a closed system with the aid of a stock pump (9) without being degassed by applying negative pressure again.

12. Method according to claim 1, characterized in that the fibrous suspension (S) is guided through a cleaner unit (17) after the degassing device (6, 6′) with the aid of a stock pump (9) directly downstream, and that the accepts of this cleaner unit (17) are not further degassed by applying negative pressure.

13. Use of the method according to claim 1, during the operation of a paper machine, the screen speed of which is between 800 and 1600 m/min.

14. Method for feeding a fibrous suspension to at least one filter device, preferably a disk filter (35), whereby the fibrous suspension (S) is thickened through a filter process, whereby the fibrous suspension has a maximum consistency of 4%, preferably between 0.5 and 2%, characterized in that the fibrous suspension (S) is guided into at least one degassing device (6) before thickening, in which degassing device it reaches the interior (14) of a rotating rotor (13, 13′) and is put into rotation, so that the gases (7) contained are eliminated because of centrifugal forces.

15. Method according to claim 14, characterized in that the degassed diluting liquid (5) is guided out of the degassing device (6) into a separate stock pump (9).

16. Method according to claim 14, characterized in that a fibrous suspension (S′), in particular a recovered paper suspension, is cleaned of contaminants discharged with the flotation foam in a flotation unit (37) and is then thickened.

17. Method according to claim 16, characterized in that the fibrous suspension (S) cleaned in the flotation unit (37) is guided into the degassing device (6) without an interposed pump.

18. Method according to claim 1, characterized in that the fibrous suspension (S) guided into the degassing device (6) has a gas content of more than 1.5%.

19. Method according to claim 18, characterized in that the fibrous suspension (S) guided into the degassing device (6) has a gas content of more than 3%, preferably of more than 5%.

20. Method according to claim 1, characterized in that the absolute pressure in the degassing device (6, 6′) is set to at least 0.1 bar above the steam pressure of the fibrous suspension located therein.

21. Method according to claim 1, characterized in that a degassing device (6, 6′) with a rotor (13) having a cylindrical interior (14) is used, the wall of which rotor is impermeable to liquids.

22. Method according to claim 1, characterized in that a degassing device (6, 6′) with a rotor (13) having a cylindrical interior (14) is used, the wall of which rotor is permeable to liquids only in the area of the outflow (15) through which the degassed liquid is discharged.

23. Method according to claim 1, characterized in that the rotor (13, 13′) is driven by a motor (34).

24. Method according to claim 1, characterized in that the rotor (13, 13′) is driven such that a centrifugal field is generated in its interior (14, 14′) that is at least 50 times, preferably at least 10 times the acceleration of gravity.

25. Method according to claim 1, characterized in that the degassing device (6, 6′) is operated continuously.

26. Degassing device for carrying out a method according to one of the preceding claims, with a housing (23) in which a rotor (13, 13′) having an interior (14) is arranged in a rotatable manner, with an inlet (16) for adding a liquid to be degassed, whereby the inlet (16) opens into the interior (14) of the rotor (13, 13′), as well as with an outflow (15) preferably mounted tangentially for the degassed liquid, as well as with a centrally arranged degassing tube (25) to which a vacuum device (10) for removing the gas (7) escaping from the liquid is connected, whereby the rotor (13) is provided with at least one opening (27), through which a hydraulic connection with the outflow (15) is produced, characterized in that the rotor (13) is connected to a motor (34) that drives it.

27. Degassing device according to claim 26, characterized in that the rotor (13, 13′) is surrounded by a screen basket (28), the screen openings (32) of which produce a hydraulic connection between rotor (13, 13′) and outflow (15) and are suitable for screening a fibrous suspension (S) such that the major part of the fibers passes through the screen openings (32) and can be discharged as accepts (29), whereas the contaminants are held back as rejects (30) and can be drained off through a reject outlet (31).

28. Degassing device according to claim 27, characterized in that the openings (27) in the screen basket (28) are round holes with a diameter between 1 and 4 mm.

29. Degassing device according to claim 27, characterized in that the rotor (13′) is provided on its outside with clearing elements (33) to keep the screen openings (32) clear.
